(19) United States
(12) Patent Application Publication
(10) Pub. No.: US 2007/0079755 A1
(43) Pub. Date: Apr. 12, 2007

(54) Material application system having component with wireless identification capabilities

(75) Inventors: Gregory J. Strack, Strongsville, OH (US); Jeffrey A. Perkins, Amherst, OH (US); Cynthia Ann Skelton-Becker, Rocky River, OH (US); Stephen G. Nemethy, Lakewood, OH (US); Herman E. Turner, Elyria, OH (US); Kenneth A. Kreeger, Grafton, OH (US); Joseph G. Schroeder, North Royalton, OH (US)

Correspondence Address: CALFEE, HALTER & GRISWOLD, LLP, 800 SUPERIOR AVENUE, SUITE 1400, CLEVELAND, OH, 44114, US

(73) Assignee: NORDSON CORPORATION, WESTLAKE, OH (US)

(21) Appl. No.: 10/596,106

(22) PCT Filed: Jan. 28, 2005
(86) PCT No.: PCT/US05/03352

§ 371 Date: May 31, 2006

Related U.S. Application Data
(60) Provisional application No. 60/540,548, filed on Jan. 30, 2004.

(51) Int. Cl. B05B 15/12

(52) U.S. Cl. 118/326; 239/69; 118/300

(57) ABSTRACT

Material application system provided with a wireless identification technology for parts being processed and for components of the material application system. An exemplary technology is RFID. The RFID device can be used for many different functions including part identification, repair and maintenance programs, and inventory control.

### RELATED APPLICATIONS

This application claims the benefit of U.S. provisional patent application Ser. No. 60/540,548 filed on Jan. 30, 2004 for RFID IDENTIFICATION STAND AND HANDHELD DEVICE FOR MATERIAL APPLICATION, the entire disclosure of which is fully incorporated herein by reference.

### TECHNICAL FIELD OF THE INVENTION

The invention relates generally to identification techniques used in connection with material application systems. More particularly, the invention relates to simpler and more automated techniques for providing component identification and process control for a material application system.

### BACKGROUND OF THE INVENTION

Material application systems are commonly used for applying liquid and powder materials or viscous materials such as adhesives to an object, part or surface. The wide variety of material that can be applied along with an even wider variety of application processes used in connection with different parts and materials necessitates an efficient and cost effective way to identify parts that are to be processed. This identification may include geometry, size, type of material to be applied, application parameters and so on.

Typically, parts are identified for these systems visually by an operator.

In addition to part identification, a material application system typically includes any number of wear components that need routine maintenance and repair or replacement. For example, spray nozzles become worn due to flow of material through the nozzle. As material application systems become more and more complex, tracking parts and system configurations becomes more demanding.

### SUMMARY OF THE INVENTION

The invention contemplates the use of a wireless electronic identification device that accompanies a part to be processed in a material application system. In an exemplary embodiment, the invention is realized in the form of a radio frequency identification (RFD) device that is embedded in or accompanies a part that is to be processed. The identification device may provide information as to the nature of the part being processed and/or the process itself to be applied to the part.

In accordance with another aspect of the invention, one or more components of a material application system are provided with a wireless electronic identification device. In an exemplary embodiment, the invention is realized in the form of an RFID device that identifies the component. This functionality may be used for inventory control, maintenance programs, system configuration, and so on.

In accordance with another aspect of the invention, wireless identification devices may be used in combination with a part identification stand or a hand held scanner tool or device.

These and other aspects and advantages of the present invention will be appreciated and understood by those skilled in the art from the following detailed description of the exemplary embodiments in view of the accompanying drawings.

### BRIEF DESCRIPTION OF THE DRAWINGS

FIG. 1 is a functional schematic of a material application system using the present invention;

FIG. 2 is a perspective of an RFID identification stand; and

FIG. 3 is a perspective of a hand held RFID scanner.

### DETAILED DESCRIPTION OF THE EXEMPLARY EMBODIMENTS

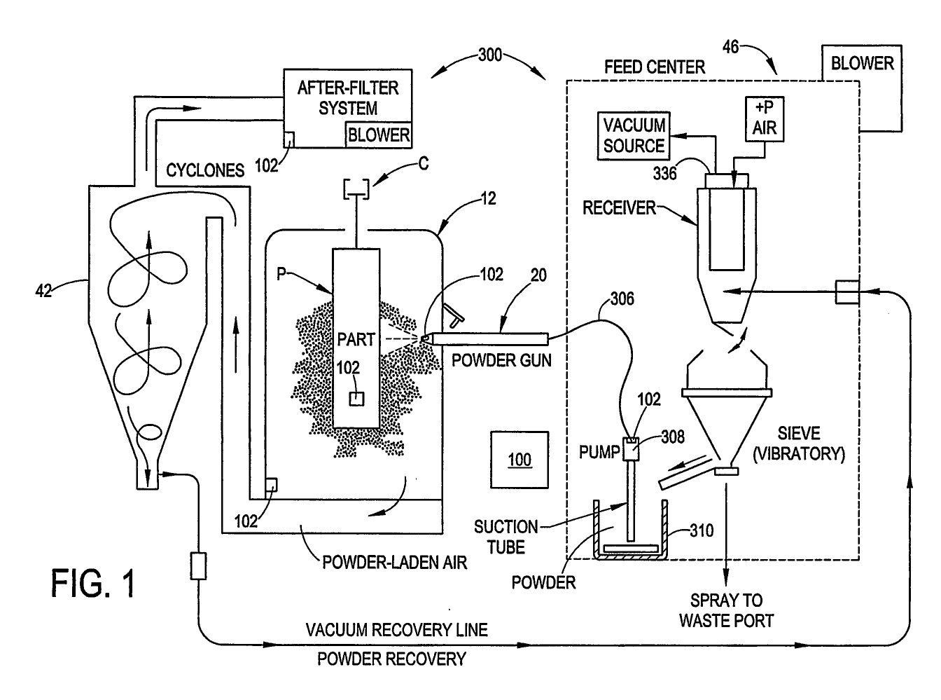

FIG. 1 illustrates a material application system 300 that incorporates an embodiment of the invention. In this particular illustration the system 300 is a powder coating material application system, however, the present invention is useful with any material application system including but not limited to liquid material, viscous material such as adhesives and so on. A typical material application system includes an application device such as a plurality of spray guns 20 (one shown in the drawing) that applies material to a part P within an enclosed or partially enclosed booth 12. The part P typically is carried on a conveyor C although parts can also be positioned within the booth on a suitable support. The spray guns 20 may be electrostatic or non-electrostatic, including corona or tribocharging guns.

In the case of a powder application system there typically is an overspray recovery arrangement such as for example a cyclone 42. Recovered powder may be returned to a feed center 46 for re-use. The feed center typically also includes a source 310 of fresh material. Material is fed to the guns 20 through a supply hose 306 from a pump 308.

Although not shown in FIG. 1, material application systems typically also include a control console or other control system arrangement. The control system is used to detect the movement and position of the parts, and the process parameters for applying material to the parts. For example, the control system may control the voltage and current for a power supply used with corona guns, or it may control air flow rates such as for the pumps 308, as well as controlling gun movers, oscillators and so on. As such, it is helpful to input to the control system information that identifies the parts to the control system. In addition, various components of the material application system 300 are susceptible to wear. Typical examples of wear items are any part that has a surface impacted by the material being applied, such as the spray nozzle for the guns 20, throats for the pumps 308 and so on. Still further, in some applications it may be useful to obtain information about the major subsystems such as the booth 12, the cyclones 42, the control consoles and so on. This information may not be required very often and possibly after long intervals of time have passed from the original installation and set-up.

In accordance with the invention, wireless electronic identification and information retrieval functionality 100 is incorporated into the material application system 300. Optionally, such identification functionality may also be incorporated into the parts P being processed.

By wireless is meant that the identification and related information can be accessed using a reader from a device associated with a part or component by an operator via a communication link that does not depend on a direct hardwired electrical connection between the device and the reader. By reader is meant any apparatus or arrangement that can extract information from the identification device.

In an exemplary embodiment of the invention, the functionality 100 is realized in the form of radio frequency identification (RFID) technology incorporated into or associated with the parts and components of interest. RFID technology is well known and in essence operates based on very small microchips that can be interrogated or communicated with in a wireless manner by incorporating one or more antennae within the chip. Although RFID technology is used in the exemplary embodiment, the invention may be used with any wireless communication and interrogation technology.

RFID includes a tag or other device 102 that can be associated with a part or component of interest. The tag or device 102 for example may be embedded in the part, surface mounted on the part, attached to the part or be incorporated into the packaging for the part. In FIG. 1 we illustrate RFID tags being used in any number of different locations and for different information needs. The tags may be used to provide product information about the part P being processed, or may be used to identify components of the material application system. The latter may be used for inventory control, repair and replacement scheduling and so on. The type of information to be conveyed via the tags can be as varied as is the types of parts processed and the components that make up the system 300.

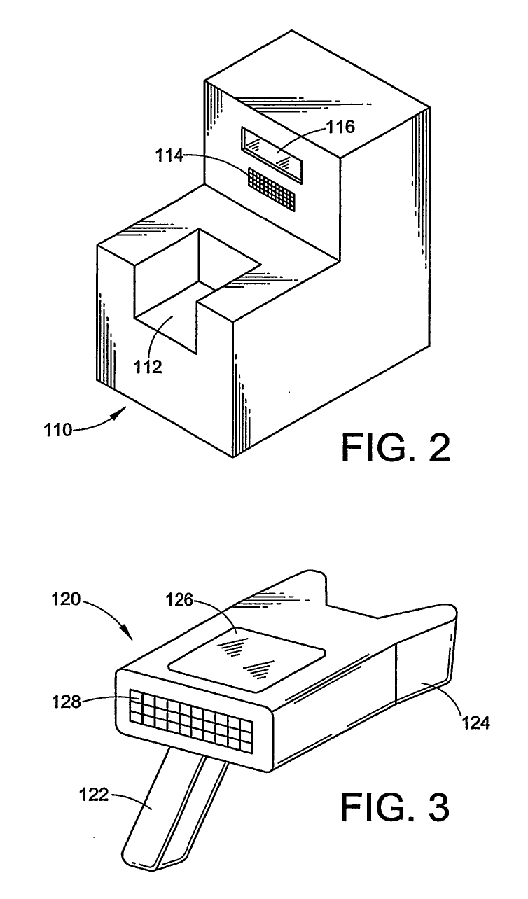

The RFID system 100 includes the separate RFID devices 102 and a scanner or reader. We illustrate two embodiments, FIG. 2 being a stand and FIG. 3 being a hand held reader or scanner.

FIG. 2 illustrates a stand 110 that can be used as a stationary (or portable) station to detect RFID devices. The stand 110 typically includes a sensor bay 112 in which a part or a box of parts can be placed. A display 116 may be provided for a visual readout of the RFID information. A keypad or other operator interface 114 is used to allow the operator to access additional information based on the RFID information which has been read. FIG. 3 illustrates a hand held device 120 that can be used to interrogate RFID devices, and includes a handle 122, a sensor 124, a readout display 126 and a keypad 128. The sensors 112, 124 may be conventional in design so as to be able to interrogate an RFID device by wireless communication, as is known in the art. The RFID system can be interfaced to other software based enterprise systems such as for inventory control, online ordering systems and so on. The RFID devices may be passive in which they are interrogated by a signal from the sensor, or active in which they transmit a signal containing the information.

An RFID device could be placed in or attached to any part or product manufactured or sold by a manufacturer of the application system 300. In the case of a wear item, for example, the part may be presented to the RFID identification stand 110 which would be provided as part of the system 300 or as an add-on feature. This stand may be provided as a part of the system controller or as a unit separate from the system controller. Electronics having RFID identifying capabilities would identify the part placed into or next to the part bay from the RFID device in the part. The RFID device may be attached to the part during manufacture such as by the use of an adhesive, or can be molded into the part, for example. The identification stand would read the RFID device in the part and would display various information relating to the parts such as the part number so that the user could determine whether a new spare part is in inventory or whether to order additional spare parts. The identification stand would include a control interface such as a keyboard and modem so that, for example, the user could order new spare parts online from the manufacturer. This RFD identification stand is shown in FIG. 2. The controller stand would also be able to determine whether the part was a part manufactured by the original manufacturer or a part manufactured by a third party.

When the part is identified by the identification stand, basic information about the part will be displayed together with a menu from which additional information about the part can be accessed. For example, by using the operator interface key pad, the operator would be able to select from the menu to display the manual page for the part which has been identified and any instructions necessary to replace the part into the product assembly. The operator could also select an option to view animated assembly instructions which would show the operator how to assemble the part back into the assembly.

In addition to providing an RFD identification stand, a handheld RFID identification device may also be provided as in FIG. 3. Whereas the parts to be identified can be taken to the identification stand as described above, the hand device provides the option of identifying the parts wherever they are located in the user's facility and could even be used to identify parts and products currently in use. The device has a handle, display, operator interface and an RFID sensor which would be pointed at the part or product to be identified.

The handheld RFID identification device could also be used to check boxes delivered by the manufacturer to the customer's plant. The RFID sensor element of the handheld device would be pointed at the box, which could remain closed. The handheld device would read the RFID devices in all parts within the box and display the contents of the box as a list of parts. This displayed information could be checked against a shipping memo taped to the outside of the box so that the contents of the box could be verified without the necessity of even opening the box. This avoids the need for opening the box and checking the parts one by one against the shipping list.

Either the identification stand or handheld device could be used to identify fully assembled products as well. When the product was placed in the bay of the identification stand, or in the case of the handheld device, when the handheld device was pointed at the assembled product, the combination of individual part numbers detected in the product would be used to identify the assembled product and display information relative to it. Similar to what was described above, a menu would be presented from which the operator could select the information he wants to see such as the manual for the product or instructions for assembly, maintenance, use or ordering. The information read from the RFID devices may also be used to indicate whether parts are missing from an assembled product, or whether incorrect parts have been assembled into a product. This can be done without disassembly of the product.

The RFID identification device could also be used in connection with inventory. Whenever a part is withdrawn from inventory it would be presented to an RFID identification stand, which could be a separate RFID stand located in the inventory area, and a new part would automatically be ordered to replace the part being taken out of inventory.

When a material application system such as a powder coating system is manufactured, an RFID device could also be secured to the base of the powder coating booth, for example, so that the system could be identified in the field. Then, possibly years later, a handheld RFID identification device could be pointed at the part of the booth base where the RFID device is secured. The handheld device would identify the system and provide a menu from which additional information could be accessed such as information indicating when the system was sold, the products and components originally sold as part of the system, any safety agency approvals received for the system and so on. The original system installation drawings including wiring and pneumatic circuit drawings could be provided as well on a nearby computer monitor in the plant.

RFID devices could also be provided on employee identification cards which the employees could present to the RFID identification stand for the system when employees are present at the system to do maintenance. This could provide the customer with the record of how frequent the manufacturer's employees are at the system doing maintenance.

The invention has been described with reference to the preferred embodiment. Modifications and alterations will occur to others upon a reading and understanding of this specification. It is intended to include all such modifications and alterations insofar as they come within the scope of the appended claims or the equivalents thereof.

We claim:

1. A material application system comprising:
a plurality of material application system components including at least a material application device for applying a material to a part and a supply of material for the application device, a wireless identification device, said wireless identification device being associated with at least one of said system components, and a sensor for receiving information from said wireless identification device.

2. The system of claim 1 wherein said application device comprises a spray gun.

3. The system of claim 1 wherein said components comprise a powder spray booth, a powder spray gun and a powder pump.

4. The system of claim 1 wherein said wireless identification device comprises an RFID device.

5. The system of claim 1 wherein said wireless identification device is associated with a wear item of the material application system.

6. The system of claim 5 wherein said wear part is selected from the group of a spray nozzle, a pump throat and a powder tube.

7. The system of claim 1 wherein said information includes part identification.

8. The system of claim 7 wherein said information includes original manufacturer information.

9. The system of claim 1 wherein said sensor is part of a hand held device.

10. An assembly comprising the combination of a wear item in a material application system and a wireless identification device comprising a circuit chip and an antenna, said device being associated with the wear item.

11. The assembly of claim 10 wherein said wireless identification device comprises an RFID device.

12. The assembly of claim 10 wherein said wear item is s spray gun nozzle.

13. The assembly of claim 10 wherein said device is affixed to or embedded in the wear item.

14. The assembly of claim 10 wherein the wear item is part of a powder spray gun or powder pump.

15. The assembly of claim 10 comprising a sensor for interrogating the device.

16. The assembly of claim 15 wherein said sensor is hand held.

17. A method for identifying parts of a material application system, comprising:
associating with the part a wireless identification device;
receiving information from said device, and
using said information as part of the operation or maintenance of the material application system.

18. The method of claim 17 comprising the step of:
associating an RFID device with the part.

19. The method of claim 17 comprising the step of:
using the information received as part of a maintenance or repair procedure.

20. The method of claim 17 wherein the part is a wear item or a system component.

21. A method for identifying parts in a container, comprising:
associating with each part in a container a wireless identification device;
receiving information from said device by using a hand held sensor, and
using said information to verify contents of the container without having to open the container.

22. A method for identifying parts of an assembled product, comprising:
associating with each of one or more parts of an assembled product a respective wireless identification device;
receiving information from each said wireless identification device, and
using said information to verify the assembled product has all required parts and that all parts in the product are correct, wherein the method is carried out without disassembly of the product.

23. The method of claim 22 comprising the step of receiving said information by positioning the assembled product in a stand having a sensor for reading the wireless devices.

24. A method for identifying parts of a material application system, comprising:
associating with one or more parts of a material application system a respective wireless identification device;
receiving information from said wireless devices using a handheld scan device,
said one or more parts including a spray booth, and using said information to identify the booth.
